(19) United States
(12) Patent Application Publication
(10) Pub. No.: US 2024/0099933 A1
(43) Pub. Date: Mar. 28, 2024

(54) MASSAGE DEVICE HAVING VIBRATION FUNCTION

(71) Applicant: Dongguan Haibang Network Technology Co.,Ltd., Dongguan (CN)

(72) Inventor: Huitang LIN, Lufeng (CN)

(73) Assignee: Dongguan Haibang Network Technology Co.,Ltd., Dongguan (CN)

(21) Appl. No.: 17/952,952

(22) Filed: Sep. 26, 2022

(51) Int. Cl. A61H 23/02; A61H 19/00

(52) U.S. Cl. CPC A61H 23/02; A61H 19/40

(57) ABSTRACT

The present invention relates to the technical field of massage devices, and discloses a massage device having a vibration function, comprising: a first housing, a second housing, a decorative cover, a massage casing, and a control panel. The first housing and the second housing are mounted with a vibration-guiding assembly, the vibration-guiding assembly is connected with a massage piece, the massage piece is a massage pen or a massage tongue, and a battery for supplying electric energy to the vibration-guiding assembly is mounted within the first housing and the second housing. The present invention facilitates the replacement of the massage head and increases the functionality of the massage device.

### TECHNICAL FIELD

The present invention relates to the technical field of massage devices, and more particularly to a massage device having a vibration function.

### BACKGROUND

A massage device is equipment for massaging a person's body, and is used for giving a user corresponding comfort. A conventional massage device includes a housing and a massage head provided on the housing. However, the massage heads of most massage devices are not replaceable, resulting in a single massage function of the massage device, which cannot adapt to the actual needs of the user.

Therefore, how to provide a massage device having a vibration function so as to facilitate the replacement of the massage head and increase the functionality of the massage device has become an urgent technical problem to be solved.

### SUMMARY

The technical problem to be solved by the present invention is how to provide a massage device having a vibration function so as to facilitate the replacement of the massage head and increase the functionality of the massage device.

To this end, according to the first aspect, an embodiment of the present invention discloses a massage device having a vibration function, comprising: a first housing, a second housing, a decorative cover, and a control panel, wherein the first housing is detachably connected to the second housing, the decorative cover is respectively clamped with and fixed to the first housing and the second housing, a vibration-guiding assembly is mounted to the first housing and the second housing, the vibration-guiding assembly is connected to a massage piece, the massage piece is a massage pen or a massage tongue, a battery for supplying electric energy to the vibration-guiding assembly is mounted within the first housing and the second housing, the battery is electrically connected to the control panel, and a massage casing is sleeved on an outer side of the first housing and the second housing.

The present invention is further configured as follows: the control panel is provided with a first key and a second key.

The present invention is further configured as follows: a first mark and a second mark are successively provided on the massage casing, the first mark corresponding to the first key, and the second mark corresponding to the second key.

The present invention is further configured as follows: the vibration-guiding assembly comprises a vibration-guiding piece clamped with the massage piece, and a driving motor and a vibration-guiding eccentric wheel are mounted in the vibration-guiding piece.

The present invention is further configured as follows: the vibration-guiding piece comprises a vibration-guiding shaft, and a vibration-guiding body having a mounting cavity, the vibration-guiding shaft passes through the massage casing and is clamped with the massage piece, and the driving motor is fixedly mounted within the mounting cavity.

The present invention is further configured as follows: the vibration-guiding piece is sleeved with a vibration-absorbing casing, the first housing is provided with a first accommodating groove, the second housing is provided with a second accommodating groove corresponding to the first accommodating groove, and the first accommodating groove and the second accommodating groove are used for wrapping the vibration-absorbing casing.

The present invention is further configured as follows: a charging base is further included. A charging post for charging the massage device is mounted on the charging base.

The present invention is further configured as follows: one end of the charging base is embedded in the first housing, and the other end of the charging base is embedded in the second housing.

The present invention is further configured as follows: a first positioning hole is provided on the first positioning hole, the second housing is provided with a second positioning hole which is arranged opposite to the first positioning hole, the massage casing is provided therein with a first positioning table and a second positioning table, the first positioning table is inserted into and mated with the first positioning hole, and the second positioning table is inserted into and mated with the second positioning hole.

The present invention is further configured as follows: a first mounting post having a threaded hole is provided in the first housing, a second mounting hole corresponding to the first mounting post is provided on the second housing, and the first housing and the second housing are fixedly connected by a screw.

The present invention has the following advantageous effects: by controlling the massage piece to vibrate via the vibration-guiding assembly, the massage piece can be a massage pen or a massage tongue, and the massage pen or the massage tongue can provide a user with different massage feelings, thereby providing a massage device having a vibration function, facilitating the replacement of a massage head, and increasing the functionality of the massage device.

### BRIEF DESCRIPTION OF DRAWINGS

In order to illustrate the technical solutions in the prior art or the preferred embodiments of the present invention more clearly, the following will briefly introduce the drawings that need to be used in the description of the preferred embodiments or the prior art. Obviously, the drawings in the following description are some implementation modes of the present invention. For those of ordinary skills in the art, other drawings can be obtained according to these drawings without involving inventive efforts.

FIG. 1 is a schematic view illustrating a stereo-structure of a massage device having a vibration function according to the present embodiment;

FIG. 2 is a schematic cross-sectional view illustrating a massage device having a vibration function according to the present embodiment;

FIG. 3 is a schematic view showing an exploded structure of a massage device having a vibration function according to the present embodiment;

FIG. 4 is a schematic view showing a structure of a vibration-guiding assembly in a massage device having a vibration function according to the present embodiment;

FIG. 5 is a schematic cross-sectional view of a massage casing in a massage device having a vibration function according to the present embodiment;

FIG. 6 is a schematic view illustrating a stereo-structure of another massage device having a vibration function according to the present embodiment;

FIG. 7 is a schematic view showing a structure of a massage tongue in another massage device having a vibration function according to the present embodiment;

FIG. 8 is a schematic view showing an exploded structure of a massage tongue in another massage device having a vibration function according to the present embodiment;

FIG. 9 is a schematic view showing an exploded structure of a first housing and a second housing in a massage device having a vibration function according to the present embodiment.

Reference numerals: 1. first housing; 2. second housing; 3. decorative cover; 31. locking hook; 4. control panel; 5. vibration-guiding assembly; 51. vibration-guiding piece; 511. vibration-guiding shaft; 512. vibration-guiding body; 5121. mounting cavity; 513. vibration-absorbing casing; 52. driving motor; 53. vibration-guiding eccentric wheel; 6. massage pen; 7. massage tongue; 8. battery; 9. massage casing; 91. first mark; 92. second mark; 93. first positioning table; 94. second positioning table; 10. first key; 11. second key; 12. first accommodating groove; 13. second accommodating groove; 14. charging base; 15. charging post; 16. first positioning hole; 17. second positioning hole; 18. first mounting post; 19. second mounting hole; 20. first locking table; 21. second locking table; 22. protruding strip; and 23. groove.

### DETAILED DESCRIPTION OF THE EMBODIMENTS

In order to make the object, technical solutions, and advantages of the present invention more apparent, a more particular description of the present invention will be rendered below with reference to the accompanying drawings and embodiments. It should be understood that the specific embodiments described herein are merely illustrative of the present invention and are not intended to be limiting thereof.

In describing the present invention, it needs to be noted that unless otherwise expressly specified and limited, the terms “mounted” “connected”, and “connecting” should be interpreted broadly. For example, it can be a fixed connection or a detachable connection, or an integrated connection; it can be a mechanical connection, or an electrical connection; it can be directly connected or indirectly connected through an intermediate medium, and it can also be the communication within two elements, and it can be a wireless connection or a wired connection. For a person of ordinary skills in the art, the specific meaning of the above-mentioned terms in the present invention can be understood according to specific situations.

In the description of the present invention, it needs to be noted that the orientation or positional relationships indicated by the terms “center”, “up”, “down”, “left”, “right”, “vertical”, “horizontal”, “inner”, “outer”, etc. are based on the orientation or positional relationship shown in the drawings, and are only for the convenience of describing the invention and simplifying the description, rather than indicating or implying that the referred device or element must have a specific orientation, or be constructed and operated in a specific orientation, and therefore cannot be construed as a limitation of the present invention. Furthermore, the terms “first”, “second”, and “third” are only used for descriptive purposes and are not to be construed as indicating or implying relative importance.

Furthermore, the technical features involved in the different implementation modes of the present invention described below can be combined with each other as long as they do not conflict with each other.

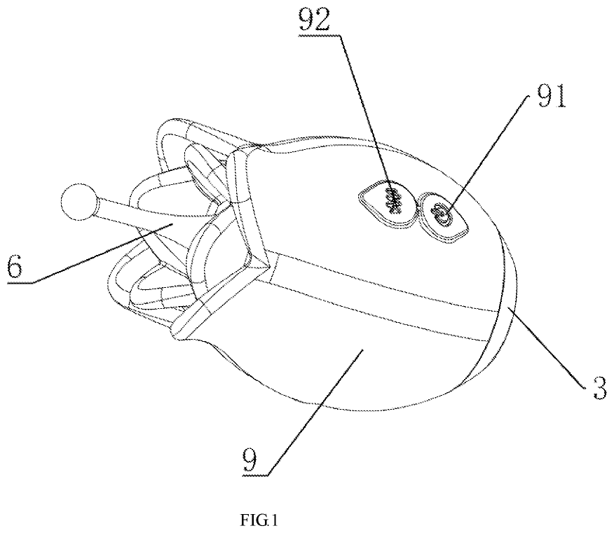

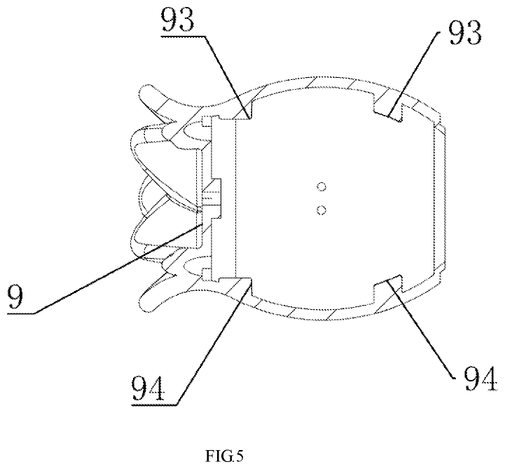

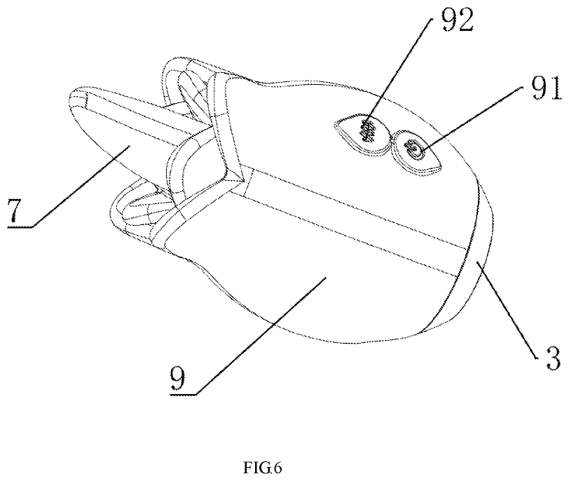

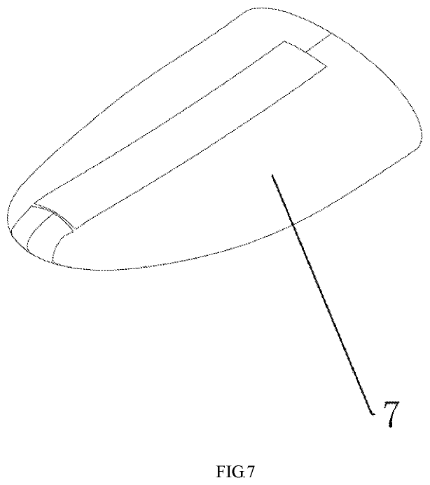

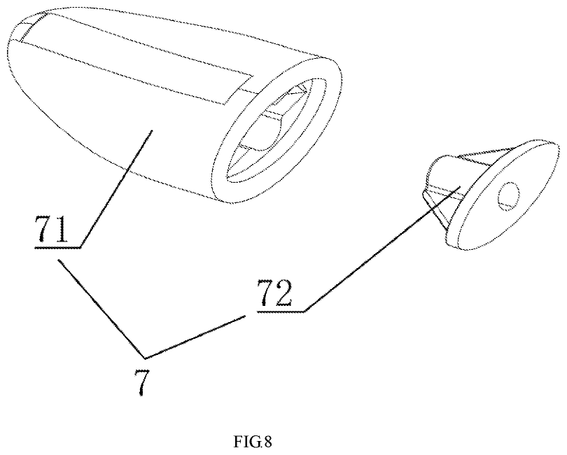

An embodiment of the present invention discloses a massage device having a vibration function, as shown in FIGS. 1-9, comprising: a first housing 1, a second housing 2, a decorative cover 3, and a control panel 4. The first housing 1 is detachably connected to the second housing 2, the decorative cover 3 is respectively clamped with and fixed to the first housing 1 and the second housing 2, a vibration-guiding assembly 5 is mounted to the first housing 1 and the second housing 2, a massage piece is connected to the vibration-guiding assembly 5, the massage piece is a massage pen 6 or a massage tongue 7, a battery 8 for supplying electric energy to the vibration-guiding assembly 5 is mounted within the first housing 1 and the second housing 2, the battery 8 is electrically connected to the control panel 4, and a massage casing 9 is sleeved on the outer side of the first housing 1 and the second housing 2. In a specific implementation process, the decorative cover 3 is provided with two locking hooks 31, the first housing 1 is provided with a first locking table 20 snap-fitted with the locking hooks 31, and the second housing 2 is provided with a second locking table 21 snap-fitted with the locking hook 31; the first housing 1 is provided with a protruding strip 22, and the second housing 2 is provided with a groove 23 adapted to the protruding strip 22. In a specific implementation process, the massage pen 6 is made of a hard material, and the massage tongue 7 comprises a tongue body and a connecting piece. The connecting piece is inserted into the tongue body, the tongue body is made of a soft material, and the connecting piece is made of hard material.

It needs to be noted that by controlling the massage piece to vibrate via the vibration-guiding assembly 5, the massage piece can be a massage pen 6 or a massage tongue 7, and the massage pen 6 or the massage tongue 7 can provide a user with different massage feelings, thereby providing a massage device having a vibration function, facilitating the replacement of a massage head, and increasing the functionality of the massage device.

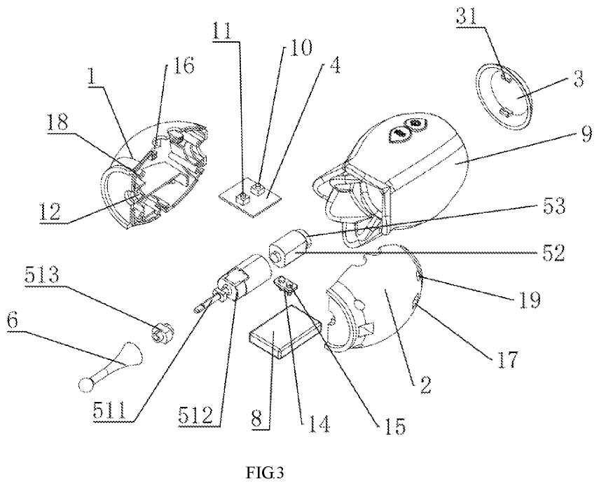

As shown in FIGS. 1 and 3, the control panel 4 is provided with a first key 10 and a second key 11. It needs to be noted that the first key 10 is used for controlling the on/off state of the massage device, the second key 11 is used for controlling the vibration frequency of the vibration-guiding assembly 5, and the vibration frequency of the vibration-guiding assembly 5 can be adjusted through the control function of the second key 11, so as to adapt to various massage requirements of a user.

As shown in FIGS. 1 and 3, the massage casing 9 is successively provided with a first mark 91 and a second mark 92, wherein the first mark 91 corresponds to the first key 10, and the second mark 92 corresponds to the second key 11.

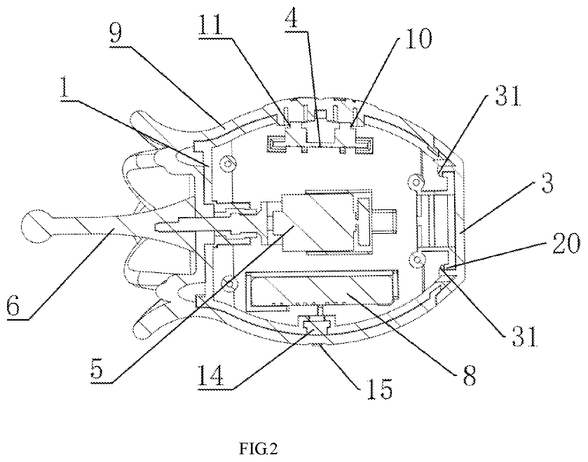

As shown in FIGS. 2-4, the vibration-guiding assembly 5 comprises a vibration-guiding piece 51 clamped with the massage piece, and a driving motor 52 and a vibration-guiding eccentric wheel 53 are mounted in the vibration-guiding piece 51. It needs to be noted that the vibration-guiding eccentric wheel 53 is driven to rotate by the driving action of the driving motor 52, and then the vibration-guiding piece 51 is driven to vibrate. Since the vibration-guiding piece 51 is clamped with the massage piece, the massage piece is driven to start vibrating.

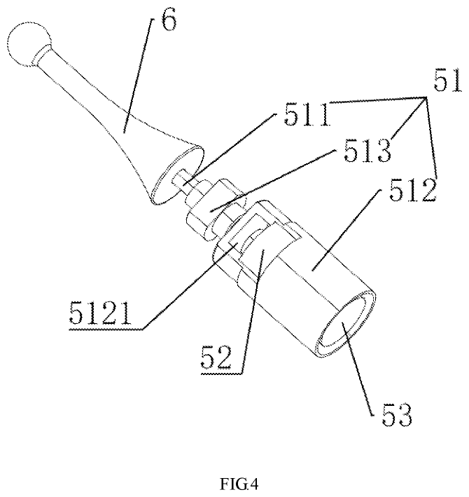

As shown in FIGS. 3 and 4, the vibration-guiding piece 51 comprises a vibration-guiding shaft 511, and a vibration-guiding body 512 having a mounting cavity 5121. The vibration-guiding shaft 511 passes through the massage casing 9 and is clamped with the massage piece, and the driving motor 52 is fixedly mounted in the mounting cavity 5121. In a specific implementation process, the vibration-guiding shaft 511 is clamped with the massage pen 6 or the connecting piece, respectively.

As shown in FIGS. 3 and 4, the vibration-guiding piece 51 is sleeved with a vibration-absorbing casing 513, the first housing 1 is provided with a first accommodating groove 12, the second housing 2 is provided with a second accommodating groove 13 corresponding to the first accommodating groove 12, and the first accommodating groove 12 and the second accommodating groove 13 are used for wrapping the vibration-absorbing casing 513. It needs to be noted that the vibration-absorbing casing 513 is sleeved with the vibration-guiding piece 51 so that the friction between the vibration-guiding piece 51 and the first housing 1 and the second housing 2 is reduced so as to reduce the noise of the massage device, thereby improving the user's using experience.

As shown in FIGS. 1-3, a charging base 14 is further included. A charging post 15 for charging the massage device is mounted on the charging base 14. In a specific implementation process, the number of the charging posts 15 is set as two, the charging posts 15 are electrically connected to the control panel 4, and the massage device is easily charged by the arrangement of the magnetic type charging posts 15.

As shown in FIGS. 1-3, one end of the charging base 14 is embedded in the first housing 1, and the other end of the charging base 14 is embedded in the second housing 2. In a specific implementation process, the charging post 15 is electrically connected to the control panel 4 and the battery 8, respectively.

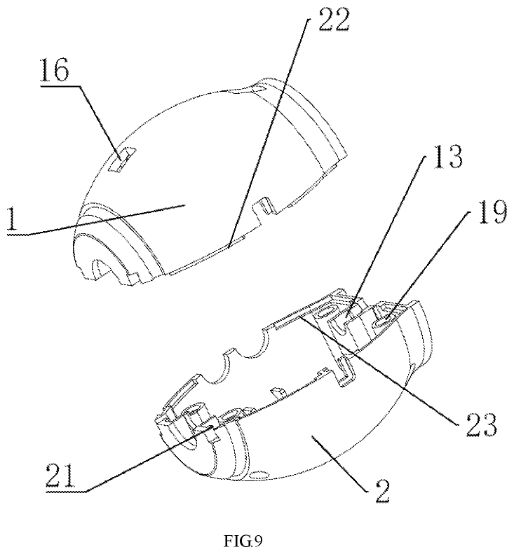

As shown in FIGS. 3 and 9, the first housing 1 is provided with a first positioning hole 16, the second housing 2 is provided with a second positioning hole 17 arranged opposite to the first positioning hole 16, the massage casing 9 is provided therein with a first positioning table 93 and a second positioning table 94, the first positioning table 93 is inserted into and mated with the first positioning hole 16, and the second positioning table 94 is inserted into and mated with the second positioning hole 17. It needs to be noted that the massage casing 9, the first positioning table 93, and the second positioning table 94 are all of an integrally formed structure. The massage casing 9 is made of a soft material, and the first positioning table 93 is inserted into and mated with the first positioning hole 16, and the second positioning table 94 is inserted into and mated with the second positioning hole 17.

As shown in FIGS. 3 and 9, a first mounting post 18 having a threaded hole is provided in the first housing 1, a second mounting hole 19 corresponding to the first mounting post 18 is provided on the second housing 2, and the first housing 1 and the second housing 2 are fixedly connected via a screw. It needs to be noted that the screw is connected to the threaded hole to facilitate the disassembly and mounting of the first housing 1 and the second housing 2.

Working principle: by controlling the massage piece to vibrate via the vibration-guiding assembly 5, the massage piece can be a massage pen 6 or a massage tongue 7, and the massage pen 6 or the massage tongue 7 can provide a user with different massage feelings, thereby providing a massage device having a vibration function, facilitating the replacement of a massage head, and increasing the functionality of the massage device.

Obviously, the above-mentioned embodiments are only examples for clear description, and are not intended to limit the implementation mode. For those of ordinary skill in the art, changes or modifications in other different forms can also be made on the basis of the above description. There is no need to be and cannot be exhaustive of all implementation modes herein. Obvious modifications or variations derived from this are still within the protection scope of the present invention.

What is claimed is:

1. A massage device having a vibration function, characterized by comprising: a first housing (1), a second housing (2), a decorative cover (3), and a control panel (4), wherein the first housing (1) is detachably connected to the second housing (2), the decorative cover (3) is respectively clamped with and fixed to the first housing (1) and the second housing (2), a vibration-guiding assembly (5) is mounted to the first housing (1) and the second housing (2), the vibration-guiding assembly (5) is connected to a massage piece, the massage piece is a massage pen (6) or a massage tongue (7), a battery (8) for supplying electric energy to the vibration-guiding assembly (5) is mounted within the first housing (1) and the second housing (2), the battery (8) is electrically connected to the control panel (4), and a massage casing (9) is sleeved on an outer side of the first housing (1) and the second housing (2).

2. The massage device having a vibration function according to claim 1, characterized in that the control panel (4) is provided with a first key (10) and a second key (11).

3. The massage device having a vibration function according to claim 2, characterized in that a first mark (91) and a second mark (92) are successively provided on the massage casing (9), the first mark (91) corresponding to the first key (10), and the second mark (92) corresponding to the second key (11).

4. The massage device having a vibration function according to claim 1, characterized in that the vibration-guiding assembly (5) comprises a vibration-guiding piece (51) clamped with the massage piece, and a driving motor (52) and a vibration-guiding eccentric wheel (53) are mounted in the vibration-guiding piece (51).

5. The massage device having a vibration function according to claim 4, characterized in that the vibration-guiding piece (51) comprises a vibration-guiding shaft (511) and a vibration-guiding body (512) having a mounting cavity (5121), the vibration-guiding shaft (511) passes through the massage casing (9) and is clamped with the massage piece, and the driving motor (52) is fixedly mounted within the mounting cavity (5121).

6. The massage device having a vibration function according to claim 4, characterized in that the vibration-guiding piece (51) is sleeved with a vibration-absorbing casing (513), the first housing (1) is provided with a first accommodating groove (12), the second housing (2) is provided with a second accommodating groove (13) corresponding to the first accommodating groove (12), and the first accommodating groove (12) and the second accommodating groove (13) are used for wrapping the vibration-absorbing casing (513).

7. The massage device having a vibration function according to claim 1, characterized by further comprising a charging base (14) on which a charging post (15) for charging the massage device is mounted.

8. The massage device having a vibration function according to claim 7, characterized in that one end of the charging base (14) is embedded in the first housing (1), and the other end of the charging base (14) is embedded in the second housing (2).

9. The massage device having a vibration function according to claim 1, characterized in that a first positioning hole (16) is provided on the first housing body (1), a second positioning hole (17) opposite to the first positioning hole (16) is provided on the second housing body (2), a first positioning table (93) and a second positioning table (94) are provided in the massage casing (9), the first positioning table (93) is inserted into and mated with the first positioning hole (16), and the second positioning table (94) is inserted into and mated with the second positioning hole (17).

10. The massage device having a vibration function according to claim 1, characterized in that a first mounting post (18) having a threaded hole is provided in the first housing (1), a second mounting hole (19) corresponding to the first mounting post (18) is provided on the second housing (2), and the first housing (1) and the second housing (2) are fixedly connected by a screw.
